(19) United States
(12) Patent Application Publication
(10) Pub. No.: US 2018/0245597 A1
(43) Pub. Date: Aug. 30, 2018

(54) ELECTRIC FLUID PUMP

(71) Applicant: HITACHI AUTOMOTIVE SYSTEMS, LTD., Hitachinaka-shi, Ibaraki (JP)

(72) Inventors: Kenya TAKARAI, Hitachinaka-shi, Ibaraki (JP); Kunito NOGUCHI, Isesaki-shi, Gunma (JP)

(73) Assignee: HITACHI AUTOMOTIVE SYSTEMS, LTD., Hitachinaka-shi, Ibaraki (JP)

(21) Appl. No.: 15/758,697

(22) PCT Filed: Jul. 26, 2016
(86) PCT No.: PCT/JP2016/071838

§ 371 Date: Mar. 8, 2018

(30) Foreign Application Priority Data
Sep. 16, 2015 (JP) 2015-182406

(51) Int. Cl. F04D 13/06; F04D 29/18; H02K 3/34; H02K 3/52; H02K 3/38

(52) U.S. Cl. CPC F04D 13/06; F04D 29/18; H02K 2203/06; H02K 3/52; H02K 3/38; H02K 3/34

(57) ABSTRACT

Disclosed is an electric fluid pump wherein a radial outer circumferential surface of a stator and an insulating flat surface of an insulating base part, on which crossover wire guides are mounted and which is perpendicular to the outer circumferential surface of the stator, are covered with a synthetic resin coating of predetermined thickness. Since the insulating flat surface of the insulating base part on which the crossover wire guides are mounted and the outer circumferential surface of the stator are covered with the synthetic resin coating, it is possible that, even when a winding force is exerted in a radially inward direction of the stator by winding of crossover wires on the crossover wire guides, the synthetic resin coating on the outer circumferential surface of the stator suppresses changes in the mounting angles of the crossover wire guides and thereby prevents loosening of the crossover wires.

### FIELD OF THE INVENTION

The present invention relates to an electric fluid pump, particularly of the type having crossover wire guides that guide crossover wires.

### BACKGROUND ART

With the recent increasing demand for improvements in vehicle fuel efficiency, vehicles with idle stop functions and hybrid vehicles have been put into practical use. Each of these vehicles needs to have a fluid pump drive source other than an internal combustion engine in view of the fact that a fluid pump driven by an internal combustion engine is stopped during a stop of the internal combustion engine. Further, the hybrid vehicles and electric vehicles each need to have a coolant pump for cooling a drive motor and a control unit thereof or a battery. Under such circumstances, there is an increasing tendency to use an electric fluid pump that has an impeller fixed to a rotor of an electric motor and performs a pumping action by rotation of the impeller with the application of a rotational force to the rotor.

A common example of the electric motor used in the electric fluid pump is an inner-rotor type direct-current electric motor in which a rotor unit with permanent magnets is disposed inside a stator unit with three-phase windings. This inner rotor type direct-current electric motor have a plurality of winding portions formed by dividing each of the respective phase winding wires and winding the divided wire segments on a plurality of protruding poles, so that a magnetic field is produced by sequential supplying drive current to the winding portions. The winding portions of the same phases are connected to each other via crossover wires. The crossover wires are guided by crossover wire guides and routed to the winding portions of the same phases.

For example, Japanese Laid-Open Patent Publication No. 2013-21824 (Patent Document 1) discloses an electric motor of such type having crossover wire guides. In the electric motor of Patent Document 1, a substantially annular insulating base part is disposed on a stator core; connection terminals are disposed on the insulating base part; and crossover wires of windings, which are wound on a plurality of protruding poles of the stator core, are led out and connected to the connection terminals in a state of being exposed outside the insulating base part.

### PRIOR ART DOCUMENTS

### Patent Document

Patent Document 1: Japanese Laid-Open Patent Publication No. 2013-21824

### SUMMARY OF THE INVENTION

### Problem to Be Solved by the Invention

An electric fluid pump to which the present invention is applied has a configuration that: connection terminals extend in an axial direction of a stator; and a control board is arranged in a direction perpendicular to the axial direction of the stator.

As a consequence, the connection terminals and the control board are connected perpendicularly to each other. Crossover wire guides are thus shaped to extend in the axial direction of the stator such that crossover wires of respective phase windings are wound on outer circumferential surfaces of the crossover wire guides. More specifically, an insulating base part is fixed to a side surface of the stator; and the crossover wire guides are mounted in a standing manner on the insulating base part so as to extend in the axial direction of the stator.

When the crossover wires are wound on the crossover wire guides, a winding force is exerted on the crossover wire guides in an inward direction of the stator. Under such a winding force, there tends to occur a phenomenon that the mounting angles of the crossover wire guides are changed to cause loosening of the crossover wires. When the winding force is strong, there may occur not only changes in the mounting angles of the crossover wire guides but also cracks in the bottom portion of the insulating base part on which the crossover wire guides are mounted.

Further, the above problem makes it difficult to use the windings of large wire diameter and also becomes a factor that impairs improvements in the efficiency of the electric motor.

It is accordingly an object of the present invention to provide a novel electric fluid pump capable of, when crossover wires are wound on crossover wire guides, suppressing changes in the mounting angles of the crossover wire guides.

### Means for Solving the Problems

The electric fluid pump according to the present invention is characterized in that a radial outer circumferential surface of a stator and an insulating flat surface of an insulating base part on which crossover wire guides are mounted are covered with a synthetic resin coating of predetermined thickness.

In the present invention, both of the insulating flat surface of the insulating base part on which the crossover wire guides are mounted and the outer circumferential surface of the stator are covered with the synthetic resin coating as mentioned above. It is therefore possible that, when a winding force is exerted on the crossover wire guides in an inward direction of the stator by winding of the crossover wires on the crossover wire guides, the synthetic resin coating on the outer circumferential surface of the stator suppresses changes in the mounting angles of the crossover wire guides and thereby prevents loosening of the crossover wires.

### BRIEF DESCRIPTION OF DRAWINGS

FIG. 1 is an overall perspective view of an electric fluid pump to which the present invention is applicable.

FIG. 2 is a perspective view of the electric fluid pump after removing a pump cover from the electric fluid pump of FIG. 1.

FIG. 3 is a perspective view of an electric motor after being taken out of the electric fluid pump of FIG. 2.

FIG. 4 is a perspective view of the electric motor after removing a control board from the electric motor of FIG. 3.

FIG. 5 is a vertical cross-sectional view of the electric fluid pump of FIG. 1.

FIG. 6 is a perspective view of a stator unit, with crossover wires omitted from illustration, after removing a holder from the electric motor of FIG. 4.

FIG. 7 is an enlarged view of a part of the stator unit of FIG. 6 in the vicinity of a connection terminal and crossover wires.

FIG. 8 is a top view of the stator unit before the formation of the synthetic resin coating.

FIG. 9 is a vertical cross-sectional view of the stator unit as taken along line A-A of FIG. 8.

FIG. 10 is an external perspective view of the stator unit before the formation of the synthetic resin coating.

FIG. 11 is a top view of the stator unit after the formation of the synthetic resin coating.

FIG. 12 is a vertical cross-sectional view of the stator unit as taken along line B-B of FIG. 11.

FIG. 13 is an external perspective view of the stator unit after the formation of the synthetic resin coating.

### DESCRIPTION OF EMBODIMENTS

Hereinafter, embodiments of the present invention will be described below with reference to the drawings. It should however be understood that: the present invention is not limited to the following embodiments; and various modification examples and application examples of the following embodiments are possible within the technical scope of the present invention.

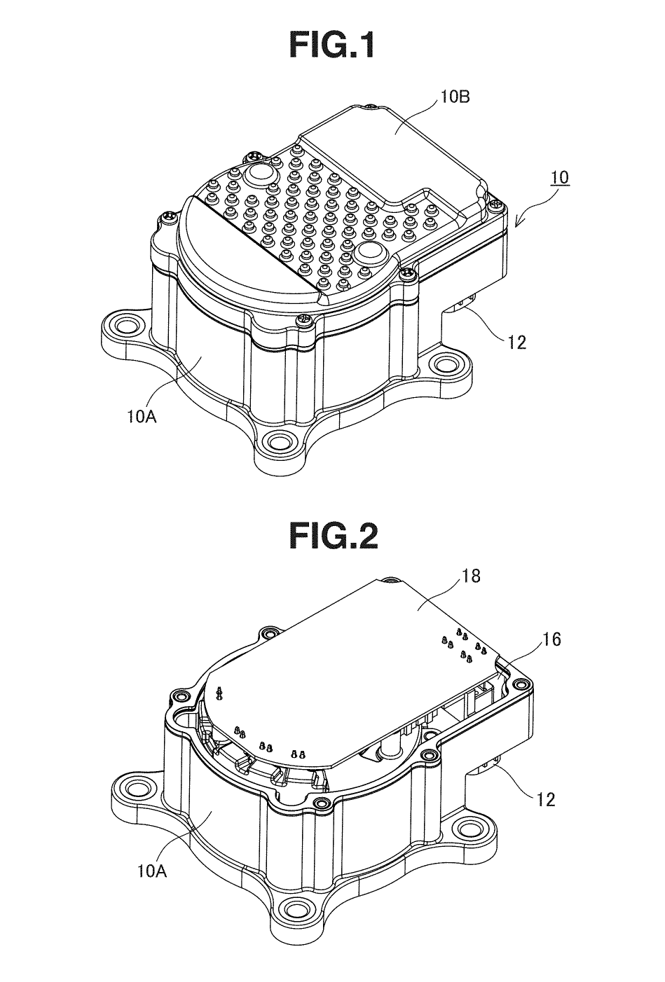

An electric fluid pump according to one embodiment of the present invention will be first explained below with reference to the drawings. FIG. 1 is a perspective view showing the overall configuration of the electric fluid pump. The electric fluid pump 10 includes: a pump body 10A formed of an aluminum alloy or the like; and a cover 10B formed of a metal material such as aluminum alloy and located adjacent to the pump body 10A so as to cover a drive control unit that is coupled to the pump body 10A. The electric fluid pump 10 is fixed in a pump housing (not shown) and is configured to perform a pumping action by rotation of an impeller that is fitted to a front end of a rotation shaft. An external connector 12 is drawn out from the pump body 10A for power supply from a battery (not shown). The cover 10B, made of metal, is equipped with a heat sink function so as to dissipate heat from the drive control unit to the outside.

FIG. 2 is a perspective view of the electric fluid pump 10 after the removal of the cover 10B. An electric motor (not shown) is arranged in the pump body 10A. The whole of the electric motor is surrounded by and covered with synthetic resin. A box-shaped housing member 16 is located in the pump body 10A while being connected to a portion of the outer circumference of the electric motor. The after-mentioned electronic components and the above-mentioned external connector 12 are placed in the housing member 16.

A control board 18 is disposed on and fixed to an upper side of the electric motor. A drive control circuit is arranged between the electric motor and the control board 18. This drive control circuit has a circuit configuration required for inverter control of the electric motor.

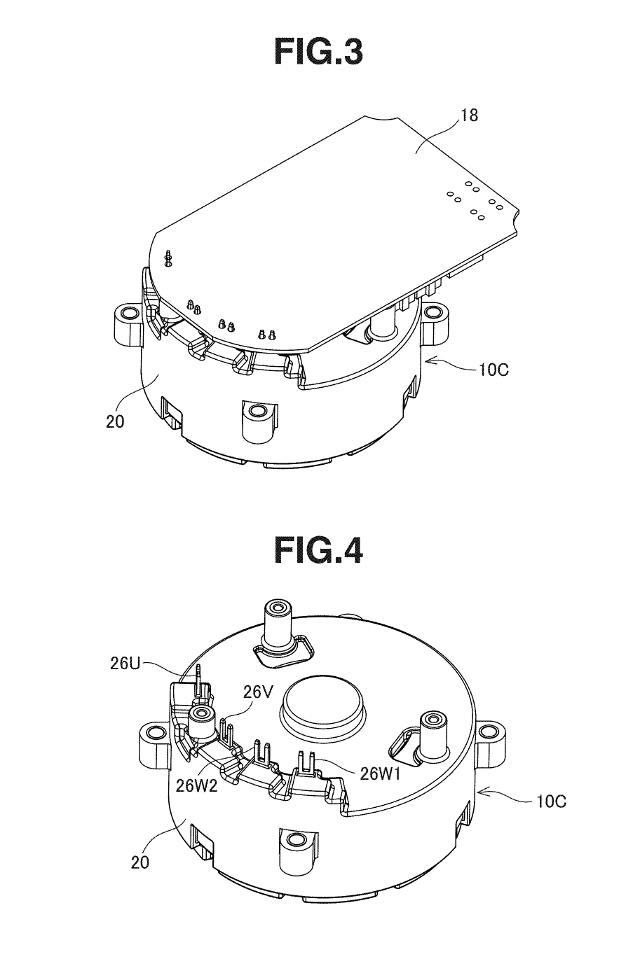

FIG. 3 is a perspective view of the electric motor 10C after being taken out from the pump body 10A. The electric motor 10C has: a stator unit 20; a rotor unit (not shown) disposed inside the stator unit; and rotation shaft fixed to the rotor unit.

FIG. 4 is a perspective view of the electric motor 10C after the removal of the control board 18. The electric motor has connection terminals 26 for electrical connections of the control board 18 to windings of the stator unit 20. In the present embodiment, a U-phase connection terminal 26U, a V-phase connection terminal 26V and W-phase connection terminals 26W1 and 26W2 are provided as the connection terminals to establish electrical connections between the control board 18 and the respective windings of the stator unit 20. The U-phase connection terminal 26U, the V-phase connection terminal 26V and the W-phase connection terminals 26W1 and 26W2 are connected to respective phase inputs of the control board 18.

The U-phase connection terminal 26U, the V-phase connection terminal 26V and the W-phase connection terminals 26W1 and 26W2 extend in an axial direction of the stator unit 20 and make connections to the control board 18, whereas the control board 18 is arranged in a direction perpendicular to the axial direction of the stator unit 20.

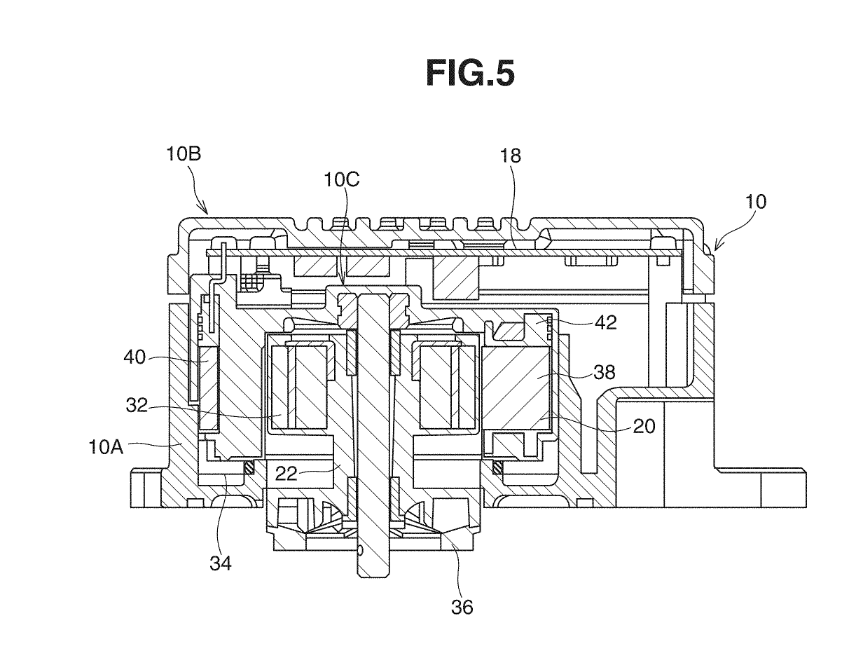

The internal configuration of the electric fluid pump will be explained in detail with reference to FIG. 5. As shown in FIG. 5, the electric motor IOC has at least the rotor unit 32 and the stator unit 20. The electric motor 10C is placed in a motor housing part 34 that is provided in one side of the pump body 10A made of metal such as aluminum alloy. The rotor unit 32 is disposed in an inner circumferential side of the stator unit 20 and is equipped with permanent magnets. The rotor unit hence receives a rotational force under the action of a magnetic field generated by winding portions 40 of the stator unit 20.

A part of the pump body 10A opposite to the motor housing part 34 is fixed to the pump housing (not shown). The impeller 36, which performs a pumping action, is disposed in this part and is rotated by the rotation shaft 22. The rotation shaft 22 is fixed to the rotor unit 32 of the electric motor 10C. Thus, the rotation shaft 32 rotates with rotation of the rotor unit 32.

The electric motor housing part 34 is fluid-tightly sealed from the impeller 36 so that a fluid does not enter the electric motor housing part. In the electric motor housing part 34, a core 38 of the stator unit 20 is placed with the winding portions 40 wound on protruding poles (not shown) of the core 38. Crossover wire guides 42, which have crossover wire holding grooves to guide and hold therein crossover wires each for connecting the winding portions 40 of the same phase, are also placed in the electric motor housing part 34. The configuration of the crossover wire guides 42 will be explained in detail later.

The crossover wire guides 42 are formed in a standing manner at locations between the protruding poles. The crossover wire guides 42 are also formed on the back sides of the protruding poles so as to guide the crossover wires.

The stator unit 20 is fixedly covered with synthetic resin. The control board 18 is coupled to the stator unit 20 in a state that both of the stator unit 20 and the synthetic resin are fixed. The circuit required for inverter control of the electric motor is mounted on the control board 18 as mentioned above, and is connected to the winding portions 40 through the U-phase connection terminal 26U, the V-phase connection terminal 26V and the W-phase connection terminals 26W1 and 26W2. Electronic components such as inductor and capacitor are disposed on an end portion of the control board 18. A part of these large-shape electronic components are accommodated in the housing member 16. As the above-structured electric fluid pump is already well known, a further explanation of the electric fluid pump will be omitted herefrom.

As mentioned above, the electric fluid pump has a configuration that: the connection terminals 26 extend in the axial direction of the stator unit 20; and the control board 18 lies in the direction perpendicular to the axial direction of the stator unit 20. The crossover wire guides 42 are thus shaped to extend in the axial direction of the stator unit 20 such that the respective phase crossover wires are wound on the outer circumferential surfaces of the crossover wire guides 42.

In such a configuration, there tends to occur a phenomenon that, when the crossover wires are wound on the crossover wire guides 42, a winding force is exerted on the crossover wire guides in an inward direction of the stator unit 20 so that the mounting angles of the crossover wire guides 42 are changed by inclination to cause loosening of the crossover wires. Herein, an insulating base part is disposed on a side surface of the stator unit; and the crossover wire guides 42 are mounted in a standing manner on the insulating base part in the axial direction of the stator unit. When the winding force is strong, there may occur not only changes in the mounting angles of the crossover wire guides but also cracks in the bottom portion of the insulating base part on which the crossover wire guides are mounted.

Hence, the present embodiment proposes a configuration in which an radial outer circumferential surface of the stator unit 20 and an insulating flat surface of the insulating base part on which the crossover wire guides 42 are mounted are covered with a synthetic resin coating of predetermined thickness.

As both of the insulating flat surface of the insulating base part on which the crossover wire guides 42 are provided and the outer circumferential surface of the stator unit 20 are covered with the synthetic resin coating, it becomes possible that, even when a winding force is exerted on the crossover wire guides in the inward direction of the stator unit 20 by winding of the crossover wires on the crossover wire guides 42, the synthetic resin coating on the outer circumferential surface of the stator unit 20 suppresses changes in the mounting angles of the crossover wire guides and thereby prevents loosening of the crossover wires.

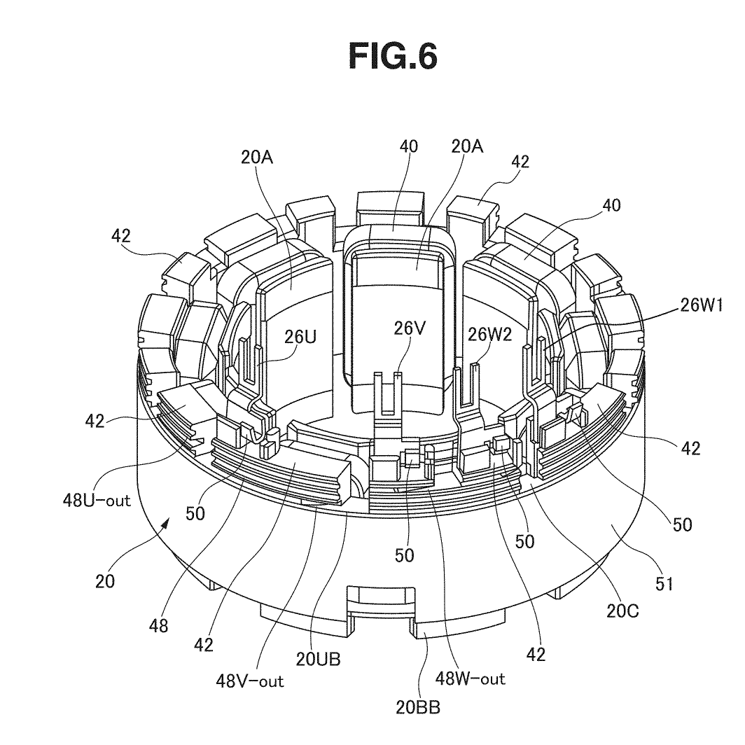

The detail configuration of the stator unit 20 of the electric motor 10C according to the present embodiment will be explained in more detail with reference to FIGS. 5 and 6. In FIGS. 5 and 6, the core 38, which constitutes a stator of the stator unit 20, is formed of a laminated silicon steel plate with nine radially inwardly protruding poles. Herein, the core 38 is an integrated type core formed simultaneously with protruding poles. Bobbins 20, made of insulating synthetic resin, are arranged on the protruding poles. Each of the bobbins 20 has the function of ensuring insulation between the winding wound on the bobbin 20A and the corresponding protruding pole. The winding portions 40 are formed by winding the respective phase windings on the bobbins 20A.

The nine protruding poles are located adjacent to one another. An upper insulating base part 20UB is disposed on one axial side surface of the core 38 at a position radially outward of the bobbins 20A on which the windings are wound. In the present embodiment, the upper insulating base part 20UB and the bobbins 20A are integrally formed by injection molding of insulating synthetic resin. The upper insulating base part 20UB protrudes by a predetermined length in the axial direction of the core 38 and has an insulating flat surface 20C formed radially in a substantially flat shape. This insulating flat surface 20C defines an upper side surface of the stator unit 20 that intersects perpendicularly with the radial outer circumferential surface of the stator core 38.

The crossover wire guides 42, which guide the crossover wires each for connecting the winding portions 40 of the same phase, are integrally formed of insulating synthetic resin on the insulating flat surface 20C so as to stand at locations between the winding portions 40. Namely, the crossover wire guides 42 are formed to extend in the axial direction from the insulating flat surface 20C of the upper insulating base part 20UB toward the control board 18.

These crossover wire guides 42 are arranged separately along the circumference of the insulating flat surface 20C at locations between the winding portions 40. The crossover wire guides 42, which guide the crossover wires, are also formed in a standing manner on the outer circumferential back sides of the winding portions 40 that protrude radially inwardly of the insulating flat surface 20C.

The upper insulating base part 20UB is mounted in advance to the stator unit 20. In this state, the insulating flat surface 20C of the upper insulating base part 20UB is integrated with the outer circumferential surface of the stator (core) by the after-mentioned synthetic resin coating 51. This configuration will be explained in more detail later.

The crossover wire holding grooves 48 are made in the outer circumferential walls of the crossover wire guides 42 that are arranged circumferentially on the insulating flat surface 20C of the upper insulating base 20UB. The crossover wires (not shown) are guided by and held in these crossover wire holding grooves 48. Although the crossover wires extend from the corresponding phase winding portions 40, the crossover wires are omitted from illustration in FIG. 6.

Further, a lower insulating base part 20BB is disposed on an axial side surface of the stator unit 20 opposite to the upper insulating base part 20UB. The lower insulating base part 20BB is also formed integrally with the bobbins. The lower insulating base part 20BB protrudes by a predetermined length in the axial direction and has an insulating surface formed radially in a substantially flat shape.

The lower insulating base part 20BB is also mounted in advance to the stator unit 20. In this state, the lower insulating base part 20BB is integrated with the outer circumferential surface of the stator (core) by the after-mentioned synthetic resin coating 51. In other words, the synthetic resin coating 51 is applied to cover not only the outer circumferential surface of the stator core 38 but also both of the insulating flat surface 20C of the upper insulating base part 20UB and the insulating flat surface of the lower insulating base part 20BB in the present embodiment.

The winding portions 40 are provided in which the windings of the respective phases are wound on the bobbins 20A with the protruding poles of the stator core being covered by the bobbins. In general, the winding portions 40 are ananged in the order of U phase, V phase and W phase. In the present embodiment, the winding of each phase is divided into three. There are thus provided, on the stator (core 38), nine bobbins 20A including a first set of first bobbins for U phase, V phase and W phase, a second set of second bobbins for U phase, V phase and W phase and a third set of third bobbins for U phase, V phase and W phase. The respective sets of bobbins are arranged in order.

The U-phase, V-phase and W-phase windings are respectively wound, from their winding start ends, on the first to third U-phase bobbins, the first to third V-phase bobbins and the first to third W-phase bobbins via the crossover wires. Lead-out ends of the U-phase, V-phase and W-phase windings are respectively led out from the third U-phase, V-phase and W-phase bobbins and connected to the corresponding connection terminals.

As shown in FIG. 6, the winding wound on the third U-phase bobbin is led out from the crossover wire guide 42 and connected to the U-phase connection terminal 26U; the winding wound on the third V-phase bobbin is led out from the crossover wire guide 42 and connected to the V-phase connection terminal 26V; and the winding wound on the third W-phase bobbin is led out from the crossover wire guide 42 and connected to the

U-phase connection terminal 26W2. In the present embodiment, the W-phase connection terminals 26W1 and 26W2 are arranged in a delta connection and are electrically connected to each other at the control board 18. Needless to say, it is alternatively feasible to adopt a star connection in the present embodiment.

The connection terminals 26U, 26V, 26W1 and 26W2 are located closer to the bobbins 20A formed on the radially inner side of the stator than the crossover wire holding grooves 48 of the crossover wire guides 42 as shown in FIGS. 5 and 6. Connection parts 50 of the connection terminals 26U, 26V, 26W1 and 26W2 to which the lead-out ends of the respective windings are connected are fowled on the outer circumferential side of the stator opposite to the bobbins 20A. Although the connection parts 50 will be explained in detail later, the connection parts 50 are shaped to clamp and sandwich therebetween the lead-out ends of the windings. The connection parts 50 of the connection terminals 26U, 26V, 26W1 and 26W2 are electrically connected to core wires of the lead-out ends of the windings by solid phase bonding with heat and pressure, i.e., passing electric current through the connection terminals 26U, 26V, 26W1 and 26W2 and thereby melting covers of the windings under heat generated from the connection terminals while holding and pressing the lead-out ends of the windings by the connection parts.

The lead-out end of the U-phase winding, which is connected to the U-phase connection terminal 26U, is led out from a lead-out section 48U-Out of the middle crossover wire holding groove of the three-groove crossover wire holding portion 48 of the crossover guide wire 42. The lead-out end of the V-phase winding, which is connected to the V-phase connection terminal 26V, is led out from a lead-out section 48V-Out of the lower crossover wire holding groove of the three-groove crossover wire holding portion 48 of the crossover wire guide 42. The lead-out end of the W-phase winding, which is connected to the W-phase connection terminal 26W, is led out from a lead-out section 48W-Out of the upper crossover wire holding groove of the three-groove crossover wire holding portion 48 of the crossover wire guide 42.

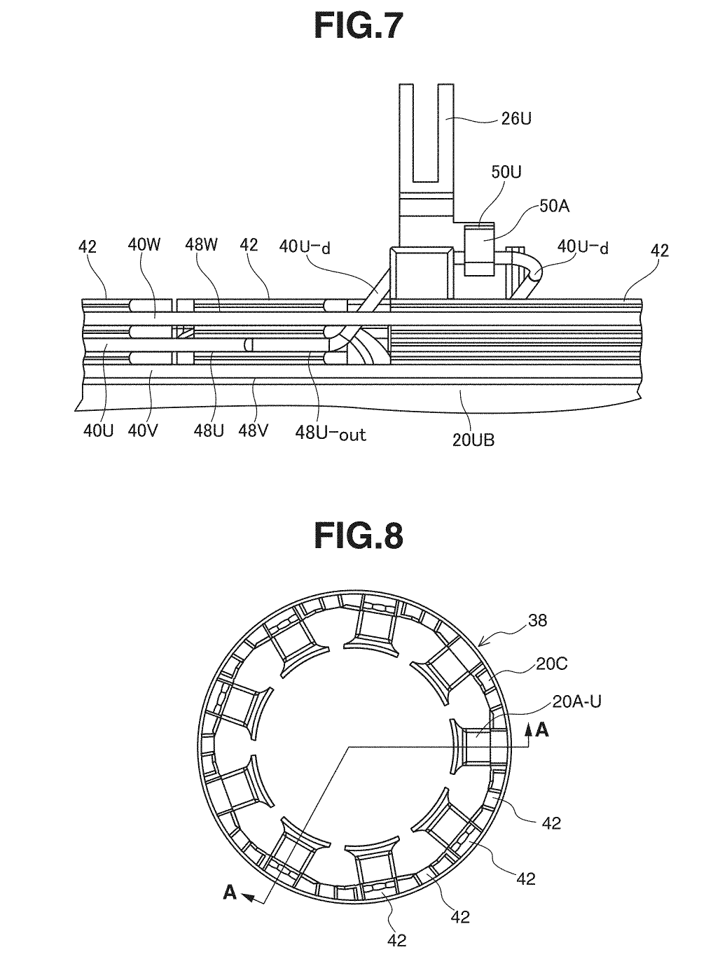

Next, the connection of the crossover wire guides 42 and the connection terminals 26U, 26v, 26W1 and 26W2 will be explained with reference to FIGS. 6 and 7. By way of typical example, the following explanation will be given of the connection of the crossover wire guide 42 and the U-phase connection terminal 26U.

The crossover wire guides 42 are integrally formed in a standing manner on the insulating flat surface 20C of the upper insulating base part 20UB such that the crossover wires, each of which connects the winding portions 40 of the same phase, are guided by the crossover wire guides 42. The phase crossover wire holding grooves 48U, 48V and 48W are formed in the outer circumferential surfaces of the crossover wire guides 42. These crossover wire holding grooves 48 are arranged in order of the W-phase crossover wire holding groove 48W, the U-phase crossover wire holding groove 48U and the V-phase crossover wire holding groove 48V from the upper side. The arrangement order of the crossover wire holding grooves are however not limited to this order and can be changed as appropriate.

The U-phase crossover wire 40U, the V-phase crossover wire 40V and the W-phase crossover wire 40W are guided and held in the corresponding crossover wire holding grooves 48U, 48V and 48W. The lead-out end 40U-d of the crossover wire 40U of the U-phase winding is led out toward the U-phase connection terminal 26U for connection of the U-phase to the U-phase connection terminal 26U. Although not specifically shown in the drawing, the lead-out end 40V-d of the crossover wire 40V of the V-phase winding is lead out toward the V-phase connection terminal 26V for connection of the V-phase winding to the V-phase connection terminal 26V; and the lead-out end 40W-d of the crossover wire 40W of the W-phase winding is lead out toward the W-phase connection terminal 26W for connection of the W-phase winding to the W-phase connection terminal 26W.

The U-phase connection terminal 26U is provided in a standing manner at a location radially inward of the outer circumferential surface of the crossover wire guide 42. The fusing connection part 50U is formed on an outer side surface of the U-phase connection terminal 26U. This fusing connection part 50U has a clamp portion 50A shaped to clamp and hold therebetween the lead-out end 40U-d of the U-phase winding. The clamp portion 50A is cut and raised from the U-phase connection terminal 26 at the side opposite to the bobbin 20A.

The lead-out end 40U-d of the U-phase winding is fused to the clamp portion 50A. As the clamp portion 50A is open at the upper side in the drawing, the fusing is performed by inserting the lead-out end 40U-d of the U-phase winding into the clamp portion 50A from the upper side and then moving down a pressure electrode of a fusing machine from the upper side. The adoption of such a configuration allows easy fusing operation. In addition, there is no fear of interference of the connection part 50 with a winding nozzle of a winding machine because the fusing connection part 50 in which the winding is clamped is formed in an outward direction of the stator. Herein, the fusing operation is done after winding process.

The following explanation will be given of the characteristic features of the present embodiment, that is, the synthetic resin coating 51 formed with a predetermined thickness over the radial outer circumferential surface of the stator and the insulating flat surface 20C of the insulating base part 20UB on which the crossover wire guides are mounted.

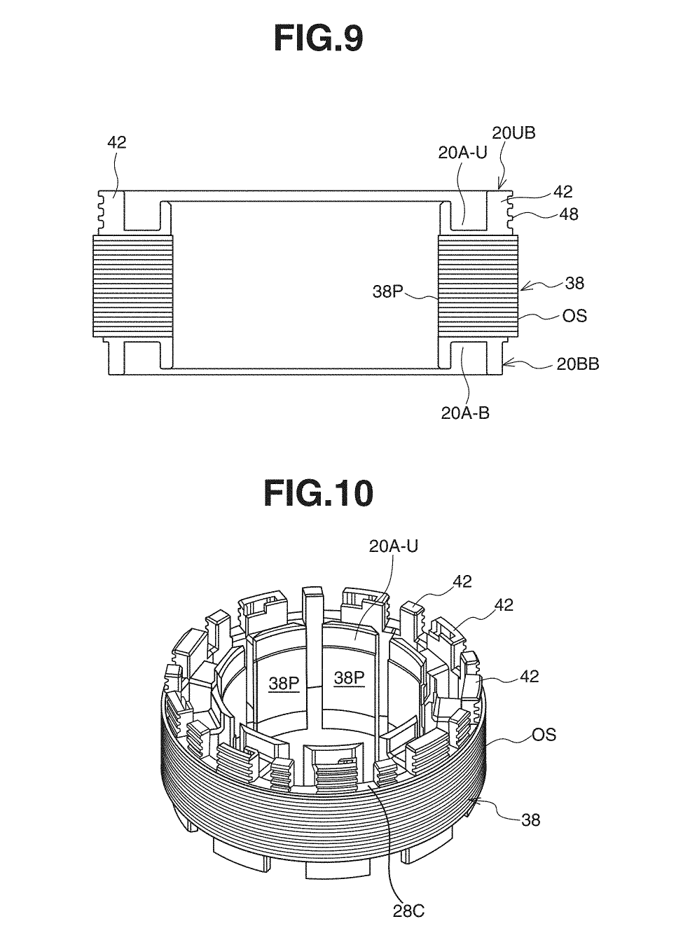

FIGS. 8 to 10 show the shape of the stator before the formation of the synthetic resin coating 51. More specifically, FIG. 8 is a top view of the stator before the formation of the synthetic resin coating 51; FIG. 9 is a cross-sectional view of the stator as taken along line A-A of FIG. 8; and FIG. 10 is an external view of the stator before the formation of the synthetic resin coating 51.

As shown in FIGS. 8 to 10, the upper insulating base part 20UB is disposed on the stator core 38 from the upper side; and the lower insulating base part 20BB is disposed on the stator core 39 from the lower side.

The upper insulating base part 20UB is annular in shape according to the cross-sectional shape of the core 38. The insulating flat surface 20C of the upper insulating base part is formed perpendicular to the outer circumferential surface OS of the core 38. The crossover wire guides 42 are formed to extend from the insulating flat surface 20C in the axial direction of the core 38. As the crossover wire guides, nine circumferentially long crossover wire guides and nine circumferentially short crossover wire guides are provided alternately in the circumferential direction. The circumferentially long crossover wire guides are located on the back sides of the winding portions 40.

Nine bobbin parts 20A-U are formed on the upper insulating base part 20UB in the radially inward direction of the core 38. These bobbin parts 20A-U cover the protruding poles 38P of the core 38 from the outer side. The respective windings are wound on the bobbin parts 20A-U during winding process.

The lower insulating base part 20BB is also annular in shape according to the cross-sectional shape of the core 38. The insulating flat surface 20C of the lower insulating base part is formed perpendicular to the outer circumferential surface OS of the core 38. Nine bobbin parts 20A-B are formed on the lower insulating base part 20BB in the radially inward direction of the core 38. These bobbin parts 20A-B cover the protruding poles 38P of the core 38 from the outer side. The respective windings are wound on the bobbin parts 20A-B during winding process. In the present embodiment, the bobbin parts 20A-U and the bobbin parts 20A-B butt each other from the upper and lower sides so as to thereby establish insulation between the windings and the protruding poles 38P.

In the present embodiment, the synthetic resin coating 51 is formed by molding such that the above-assembled stator unit is covered with the synthetic resin coating 51.

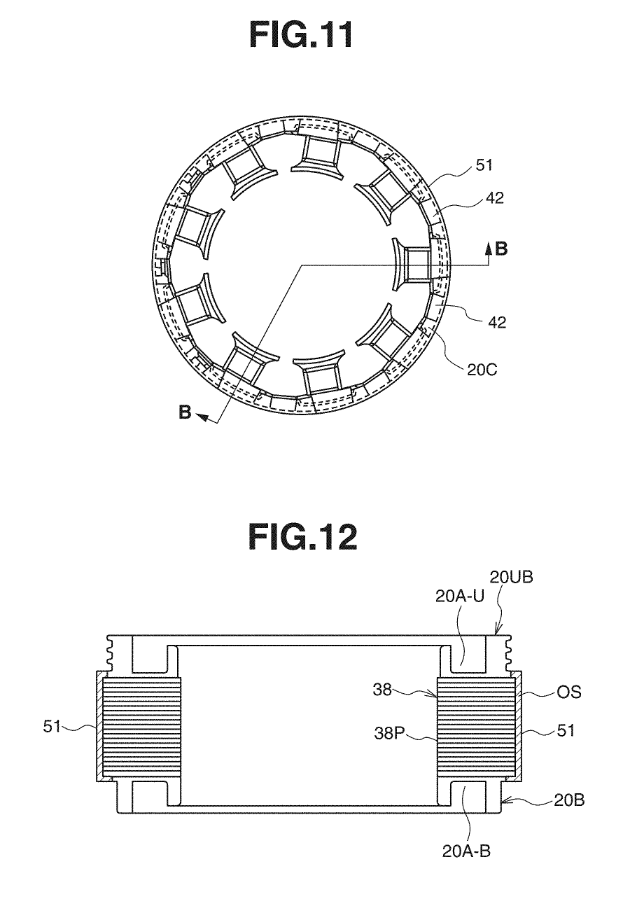

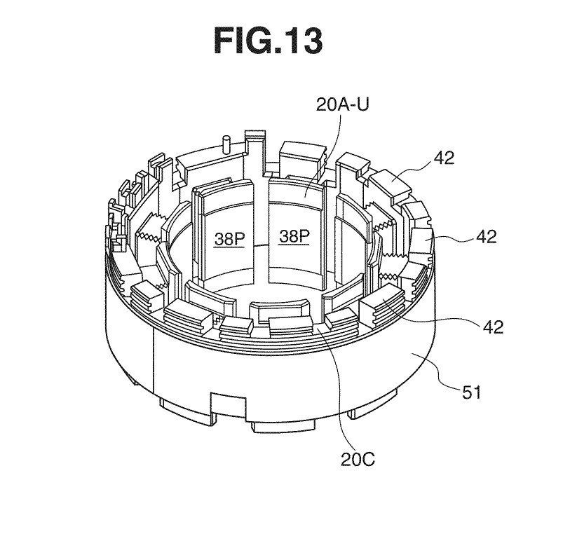

FIGS. 11 to 13 show the shape of the stator after the formation of the synthetic resin coating 51. More specifically, FIG. 11 is a top view of the stator after the formation of the synthetic resin coating 51; FIG. 12 is a cross-sectional view of the stator as taken along line B-B of FIG. 11; and FIG. 13 is an external view of the stator after the formation of the synthetic resin coating 51.

As shown in FIGS. 11 to 13, the outer circumferential surface OS of the core 38 is covered with the synthetic resin coating 51 of predetermined thickness. In the present embodiment, this synthetic resin coating 51 is formed to bond an outer circumferential edge of the insulating flat surface 20C of the upper insulating base part 20UB and an outer circumferential edge of the insulating flat surface 20C of the lower insulating base part 20BB. In this case, it is feasible to form the synthetic resin coating 51 by placing the stator of FIG. 10 in a mold and then introducing synthetic resin into the mold. As the synthetic resin, there can be used a polyphenylene sulfide resin (PPS resin). The PPS resin can suitably be used as such a molding material because of good performance in terms of heat resistance, fire retardancy, chemical resistance, dimensional stability and the like.

After the stator unit shown in FIG. 6 is produced by the above-mentioned procedure, the winding process is carried out. In the winding process, the crossover wires are wound on the crossover wire guides 42. As the crossover wires are wound with a considerably strong force on the crossover wire guides 42, a winding force is exerted on the crossover wire guides 42 in the radially inward direction. The conventional crossover wire guides 42 are inclined under such a winding force so that there arises a problem of loosening of the crossover wires caused by changes in the mounting angles of the crossover wire guides 42.

In the present embodiment, by contrast, the insulating flat surface 20C of the upper insulating base part 20UB on which the crossover wire guides 42 are mounted is bonded to the synthetic resin coating 51 on the outer circumferential surface of the stator core 38. Even when an inward winding force is exerted on the crossover wire guides 42, the synthetic resin coating 51 suppresses inclination of the crossover wire guides 42.

It is therefore possible in the present embodiment to suppress changes in the mounting angles of the crossover wire guide 42 and prevent the problem of loosening of the crossover wires. As the inclination of the crossover wire guides 42 is suppressed by the synthetic resin coating 51, it is possible to use the windings of large wire diameter for expected improvements in the efficiency of the electric motor.

On the other hand, the formation of the synthetic resin coating 51 on the stator core 38 as in the present embodiment raises a possibility of deterioration in the efficiency of the electric motor due to a decrease of heat dissipation from the stator core 38. In the present embodiment, however, a coolant flows in the pump part that is disposed on the front end of the electric motor as shown in FIG. 5. Thus, heat generated in the stator is dissipated by the coolant. It is thus possible to compensate for deterioration in the efficiency of the electric motor caused by covering the stator with the synthetic resin coating 51.

In the present embodiment, inclination of the crossover wire guides is suppressed by covering at least the outer circumferential surface of the stator and the outer circumferential edges of the insulating flat surfaces of the upper and lower insulating base parts with the synthetic resin coating. The synthetic resin coating may alternatively be formed by molding to cover the entire insulating flat surfaces of the upper and lower insulating base parts, the inner circumferential surface of the core and the circumferences of the bobbins in addition to the above surfaces. By covering the whole of the stator unit with the synthetic resin coating, it is possible to more effectively suppress inclination of the crossover wire guides and possible to use the windings of larger wire diameter.

As described above, the electric fluid pump according to the present invention is characterized in that the radial outer circumferential surface of the stator and the insulating flat surface of the insulating base part on which the crossover wire guides are mounted are covered with the synthetic resin coating of predetermined thickness.

As the insulating flat surface of the insulating base part on which the crossover wire guides are mounted and the outer circumferential surface of the stator are covered with the synthetic resin coating, it is possible that, when a winding force is exerted on the crossover wire guides in the inward direction of the stator during winding of the crossover wire on the crossover wire guides, the synthetic resin coating on the outer circumferential surface of the stator suppresses changes in the mounting angles of the crossover wire guides and prevents loosening of the crossover wires.

The present invention is not limited to the above-mentioned embodiments. The above embodiments are merely for the purpose of illustration of the present invention. The present invention does not necessarily include all of the features described with reference to the above embodiments. Any of the features of one embodiment may be substituted by those of the other embodiment. Any of the features of one embodiment may be incorporated into the other embodiment. It is conceivable to add, eliminate or replace any of the features of the above respective embodiments.

For example, the present invention can be implemented by the following aspects on the basis of the above-mentioned embodiments.

In accordance with one aspect of the present invention, there is provided an electric fluid pump, comprising: a pump part; an electric motor having a rotor unit and a stator unit; and connection terminals that supply drive signals for drive control of the electric motor, the stator unit comprising: a plurality of U-phase winding portions, a plurality of V-phase winding portions and a plurality of W-phase winding portions wound on bobbins on an inner side of the stator unit; crossover wire guides that guide crossover wires of the respective phase winding portions, the crossover wire guides being provided on an insulating flat surface of an insulating base part, which is disposed on one side surface of the stator unit, so as to extend in an axial direction of the stator unit; and a synthetic resin coating formed with a predetermined thickness and covering a radial outer circumferential surface of a stator core of the stator unit and the insulating flat surface of the insulating base part on which the crossover wire guides are provided.

In accordance with a preferable aspect of the present invention, there is provided the electric fluid pump as described above, wherein the connection terminals extend in the axial direction of the stator unit, wherein the electric fluid pump comprises a control board configured to drive and control the electric motor, the control board being arranged in a direction perpendicular to the axial direction of the stator unit and connected to the connection terminals, and wherein the crossover wires are guided by the crossover wire guide and connected to the connection terminals.

In accordance with another preferable aspect of the present invention, there is provided the electric fluid pump as described above, wherein the outer circumferential surface of the stator unit and the insulating flat surface of the insulating base part are perpendicular to each other, and wherein the connection terminals are provided on the crossover wire guides.

In accordance with still another preferable aspect of the present invention, there is provided the electric fluid pump as described above, wherein the synthetic resin coating on the outer circumferential surface of the stator unit is formed integrally with the insulating base part.

In accordance with yet another preferable aspect of the present invention, there is provided the electric fluid pump as described above, wherein another insulating base is disposed on the other side surface of the stator unit opposite to the one side surface, and wherein the synthetic resin coating on the outer circumferential surface of the stator unit is formed such that the insulating base parts on both of the one side surface and the other side surface of the stator unit is integrated with the outer circumferential surface of the stator unit.

1. An electric fluid pump, comprising:
a pump part;
an electric motor having a rotor unit and a stator unit; and
connection terminals that supply drive signals for drive control of the electric motor,
the stator unit comprising:
a plurality of U-phase winding portions, a plurality of V-phase winding portions and a plurality of W-phase winding portions wound on bobbins on an inner side of the stator unit;
crossover wire guides that guide crossover wires of the respective phase winding portions, the crossover wire guides being provided on an insulating flat surface of an insulating base part, which is disposed on one side surface of the stator unit, so as to extend in an axial direction of the stator unit; and
a synthetic resin coating formed with a predetermined thickness and covering a radial outer circumferential surface of a stator core of the stator unit and the insulating flat surface of the insulating base part on which the crossover wire guides are provided.

2. The electric fluid pump according to claim 1,
wherein the connection terminals extend in the axial direction of the stator unit,
wherein the electric fluid pump comprises a control board configured to drive and control the electric motor, the control board being arranged in a direction perpendicular to the axial direction of the stator unit and connected to the connection terminals, and
wherein the crossover wires are guided by the crossover wire guide and connected to the connection terminals.

3. The electric fluid pump according to claim 2,
wherein the outer circumferential surface of the stator unit and the insulating flat surface of the insulating base part are perpendicular to each other, and
wherein the connection terminals are provided on the crossover wire guides.

4. The electric fluid pump according to claim 3,
wherein the synthetic resin coating on the outer circumferential surface of the stator unit is formed integrally with the insulating base part.

5. The electric fluid pump according to claim 3,
wherein another insulating base is disposed on the other side surface of the stator unit opposite to the one side surface, and
wherein the synthetic resin coating on the outer circumferential surface of the stator unit is formed such that the insulating base parts on both of the one side surface and the other side surface of the stator unit is integrated with the outer circumferential surface of the stator unit.

6. The electric fluid pump according to claim 4,
wherein another insulating base is disposed on the other side surface of the stator unit opposite to the one side surface, and
wherein the synthetic resin coating on the outer circumferential surface of the stator unit is formed such that the insulating base parts on both of the one side surface and the other side surface of the stator unit is integrated with the outer circumferential surface of the stator unit.
